(19) United States
(12) Patent Application Publication
(10) Pub. No.: US 2010/0052356 A1
(43) Pub. Date: Mar. 4, 2010

(54) Suspension system for a seat assembly including an array of fluid chambers and machine using same

(75) Inventor: Charles E. Lewis, II, Normal, IL (US)

Correspondence Address: CATERPILLAR c/o LIELL, MCNEIL & HARPER;Intellectual Property Department, AH9510, 100 N.E. Adams, Peoria, IL, 61629-9510, US

(73) Assignee: Caterpillar Inc.

(21) Appl. No.: 12/231,580

(22) Filed: Sep. 4, 2008

(51) Int. Cl. B60N 2/52; A47C 31/00

(52) U.S. Cl. 296/65.02; 267/140.15; 297/219.1

(57) ABSTRACT

A suspension system for a seat assembly of a machine includes an upper support member and a lower support member. An array of fluid chambers is operatively connected to the upper and lower support members. Each of the fluid chambers includes an electronically controlled valve for controlling an amount of fluid within the fluid chambers. An elastomer is coupled between the upper support member and the lower support member. An electronic controller is in communication with each of the electronically controlled valves and is configured to actuate the valves in response to a movement of the machine.

### TECHNICAL FIELD

The present disclosure relates generally to a suspension system for a seat assembly, and more particularly to a suspension system including an array of fluid chambers.

### BACKGROUND

In many off-highway operations, a machine operator must remain seated for extended periods of time while controlling operation of the machine. Seats may be designed to permit the operator to perform tasks from a comfortable position and isolate the operator, as much as possible, from machine vibrations. These vibrations may interfere with operator control and may cause the operator to fatigue more quickly.

A variety of seat suspensions have been designed to absorb and/or dissipate the forces imparted to the seat, including passive, semi-active, and active suspension systems. According to one example, U.S. Pat. No. 6,059,253 teaches an active suspension system including six hydraulic cylinders attached to upper and lower frames of a seat assembly at angles greater than zero with respect to a generally vertical axis. A control system monitors vehicle movement and directs actuation of the hydraulic cylinders in response to the vehicle movement, thereby limiting seat movement relative to the ground.

The present disclosure is directed to one or more of the problems set forth above.

### SUMMARY OF THE DISCLOSURE

In one aspect, a suspension system for a seat assembly of a machine includes an upper support member and a lower support member. An array of fluid chambers is operatively connected to the upper and lower support members. Each of the fluid chambers includes an electronically controlled valve for controlling an amount of fluid within the fluid chambers. An elastomer is coupled between the upper support member and the lower support member. An electronic controller is in communication with each of the electronically controlled valves and is configured to actuate the valves in response to a movement of the machine.

In another aspect, a method of supporting a seat assembly of a machine includes a step of supporting the seat assembly of the machine using an array of fluid chambers surrounded, at least in part, by an elastomer. The method also includes a step of sensing a movement of the machine. The fluid amount in at least one of the fluid chambers is changed in response to the machine movement.

In yet another aspect, a seat cushion for a seat assembly of a machine includes an array of fluid chambers operatively disposed within the seat cushion. Each of the fluid chambers includes an electronically controlled valve for controlling an amount of fluid within the fluid chambers. An elastomer surrounds at least a portion of each of the fluid chambers. An electronic controller is in communication with each of the electronically controlled valves and is configured to actuate the valves in response to a movement of the machine.

### BRIEF DESCRIPTION OF THE DRAWINGS

FIG. 1 is a side diagrammatic view of a machine according to the present disclosure;

FIG. 2 is a perspective view of a seat assembly of the machine of FIG. 1; and

FIG. 3 is a perspective view of a suspension system of the seat assembly of FIG. 2.

### DETAILED DESCRIPTION

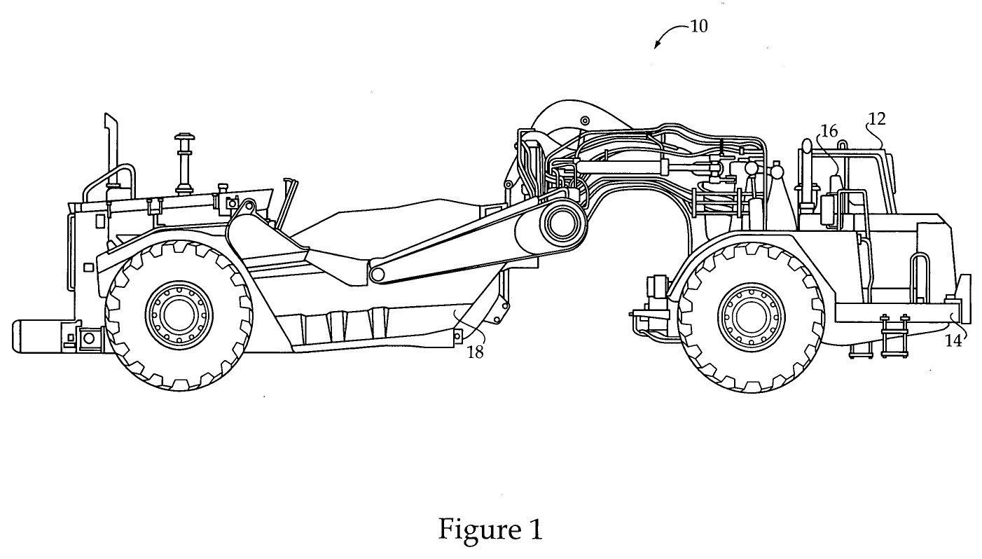

An exemplary embodiment of a machine 10 is shown generally in FIG. 1. The machine 10 may be a wheel tractor scraper, as shown, or any other machine or vehicle, having an operator control station 12. Other machines may include, but are not limited to, wheeled log skidders, track-type tractors, wheel loaders, articulated trucks, and other types of construction, mining, and agricultural machines. The operator control station 12 is mounted to a body 14 of the machine 10 and may include a seat assembly 16. The operator control station 12 may include various other devices, including, but not limited to, one or more machine operation controllers. For example, a machine operation controller may be provided for controlling movement of an implement 18, such as a scraper blade and/or bowl, of the machine 10.

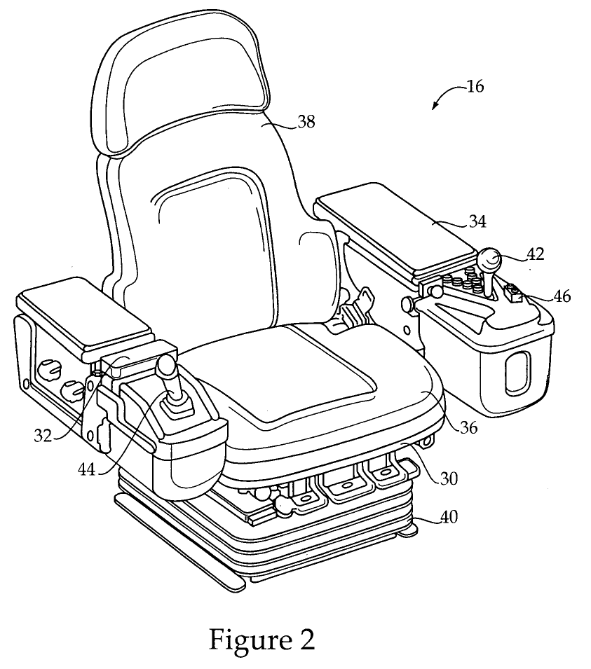

The seat assembly 16 is shown generally in FIG. 2, and includes a seat frame 30 to which a first armrest 32, a second armrest 34, a seat cushion 36, and a back 38 are attached. The seat frame 30 may include or may be mounted on a suspension system 40 or, more specifically, a seat suspension system for supporting the seat assembly 16 and damping vibrations associated with operation of the machine 10. The seat assembly 16 may also include one or more machine operation controllers, such as controllers 42 and 44 pivotably attached to the first armrest 32 and the second armrest 34, respectively. Machine operation controllers 42 and 44 may be used to control various operations of the machine 10. For example, machine operation controller 42 may include a directional controller, while machine operation controller 44 may be used to control movement of an implement of the machine 10. In addition, a height adjustment controller 46 may also be provided for controlling a height adjustment feature of the seat assembly 16.

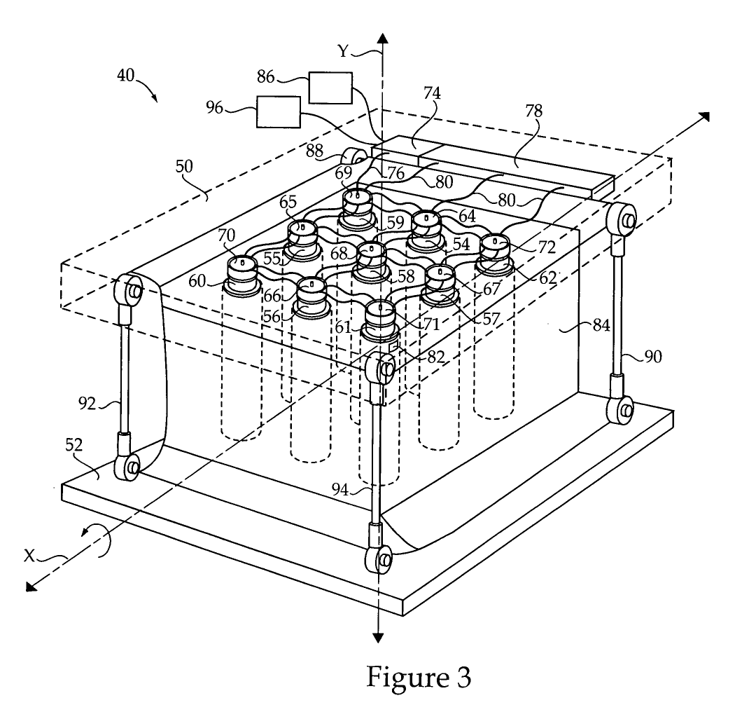

Turning now to FIG. 3, the suspension system 40 is shown in greater detail. The suspension system 40 includes an upper support member 50 and a lower support member 52. Referring again to FIGS. 1 and 2, it should be appreciated that the lower support member 52 may be attached to the machine body 14 using any known attachment means, while the upper support member 50 may have the seat cushion 36 or, alternatively, the seat frame 30 mounted thereon. Each of the upper and lower support members 50 and 52 may have a generally rectangular or square shaped structure. However, it should be appreciated that structures having various other shapes or cross sections may be substituted for the support members 50 and 52.

The upper and lower support members 50 and 52 may be interconnected by a plurality of fluid chambers, such as one or more of fluid chambers 54, 55, 56, 57, 58, 59, 60, 61, and 62. The fluid chambers 54-62 may be vertically aligned, as shown, or may be positioned at angles greater than zero with respect to a vertical axis Y. The fluid chambers 54-62 may operatively connect the upper and lower support members 50 and 52, and may be arranged in an array pattern. According to one embodiment, the array may include nine fluid chambers, such as all of the depicted fluid chambers 54-62, arranged in a three by three matrix. According to another embodiment, the array may include five fluid chambers. Specifically, fluid chambers 54, 55, 56, and 57, may operatively connect the upper and lower support members 50 and 52 at perimeters thereof, while fluid chamber 58 connects the upper and lower support members 50 and 52 at central portions thereof.

A preferred range of fluid chambers may, for example, include as few as five fluid chambers and as many as sixteen fluid chambers. Although, any number of fluid chambers is contemplated. It should be appreciated that a minimal number of fluid chambers may provide inferior control of the seat assembly 16, while a relatively large number of fluid chambers may require a decreased size of the fluid chambers and a relatively complicated control algorithm. Although preferred numbers are given for the array of fluid chambers, it should be appreciated that an “array,” as used herein, may include any number and arrangement of fluid chambers, such as, for example, a predetermined number of fluid chambers arranged in rows and columns, as shown.

The fluid chambers 54-62 may include known linear fluid actuators, or cylinders, configured to elongate or shorten based on fluid movement. Alternatively, however, the fluid chambers 54-62 may include flexible walled structures, such as, for example, pneumatic bladders or hydraulic bladders, configured to hold one of various types of fluids, such as liquids or gases. The specific dimensions and configurations of such fluid chambers 54-62 may vary depending on the desired control of the seat assembly 16. For example, the fluid chambers 54-62 may be configured to expand or shrink to predetermined shapes when a fluid amount within the fluid chambers 54-62 is increased or decreased. It should be appreciated that such movement may result in vertical movement of the upper support member 50 with respect to the lower support member 52, similar to movement permitted by linear fluid actuators. Alternatively, the walls of the fluid chambers 54-62 may be sufficiently taut, such that a firmness of the fluid chambers 54-62 may be selected by changing the fluid amount within the fluid chambers 54-62.

Each of the fluid chambers 54-62 includes an electronically controlled valve for controlling an amount of fluid within the fluid chambers 54-62. Specifically, the fluid chambers 54-62 include electronically controlled valves 64, 65, 66, 67, 68, 69, 70, 71, and 72, respectively. The electronically controlled valves 64-72, and any additional valves that may be deemed necessary, may be positioned at any desired locations along the fluid chambers 54-62. An electronic controller 74 may communicate with each of the electronically controlled valves 64-72 via one or more wired or wireless communication lines, such as communication line 76.

The electronic controller 74 may be of standard design and includes a processor, such as, for example, a central processing unit (CPU), a memory, and an input/output circuit that facilitates communication internal and external to the electronic controller 74. The processor controls operation of the electronic controller 74 by executing operating instructions, such as, for example, computer readable program code stored in memory, wherein operations may be initiated internally or externally to the electronic controller 74. A control scheme may be utilized that monitors outputs of systems or devices, such as, for example, sensors, actuators, or control units, via the input/output circuit to control inputs to various other systems or devices. Specifically, for example, the electronic controller 74 may monitor one or more motion sensing devices, such as, for example, one or more accelerometers, and actuate one or more of the electronically controlled valves 64-72 in response to the sensed motion.

The memory may comprise temporary storage areas, such as, for example, cache, virtual memory, or random access memory (RAM), or permanent storage areas, such as, for example, read-only memory (ROM), removable drives, network/internet storage, hard drives, flash memory, memory sticks, or any other known volatile or non-volatile data storage devices located internally or externally to the electronic controller 74. One skilled in the art will appreciate that any computer-based system or device utilizing similar components for controlling the electronically controlled valves 64-72 is suitable for use with the present disclosure.

The electronic controller 74 may communicate with the electronically controlled valves 64-72 to selectively vary the amount of fluid within each of the fluid chambers 54-62, such as, in response to a sensed machine movement. For example, the electronic controller 74 may communicate with the electronically controlled valves 64-72 to control the flow of fluid between a common source of fluid 78, such as a tank or accumulator, and each of the fluid chambers 54-62 via a fluid system 80. Specifically, each of the electronically controlled valves 64-72 may operate to supply fluid to or divert fluid from each of the fluid chambers 54-62. According to one embodiment, the electronically controlled valves 64-72 may also operate to release a gas from each of the fluid chambers 54-62 and into the ambient air. It should be appreciated that a pump (not shown) may also be provided for pressurizing the liquid or gas in the common fluid source 78.

Each of the fluid chambers 54-62 may include a sensor, such as, for example, a pressure sensor 82. The pressure sensor 82 may be configured to sense an amount and/or a pressure of fluid within the fluid chamber 61. The electronic controller 74 may monitor the pressure sensor 82, and additional sensors associated with fluid chambers 54-60 and 62, and adjust a control scheme for actuating the electronically controlled valves 64-72 based on the sensed pressure(s). It should be appreciated that various other sensors may also be used for detecting various conditions of the fluid chambers 54-62.

An elastomer 84 may be coupled between the upper and lower support members 50 and 52, and may include an elastomeric gel or other elastic substance having desirable spring characteristics. The elastomer 84 may surround at least a portion of each of the fluid chambers 54-62 and may provide additional support of the upper support member 50 relative to the lower support member 52. It should be appreciated that the elastomer 84 may provide support separately from and/or in conjunction with fluid chambers 54-62. For example, an increase or decrease in volume and/or firmness of one or more of the fluid chambers 54-62 may alter a spring characteristic of at least a portion of the elastomer 84. Alternatively, the elastomer 84 may influence an amount and/or direction of expansion or contraction of the fluid chambers 54-62 upon an increase or decrease in fluid within the fluid chambers 54-62.

According to one embodiment, the elastomer 84 may include a ferro-elastomeric gel responsive to a voltage source 86. For example, the ferro-elastomeric gel may include ferromagnetic or ferroelectric particles that may alter a relative stiffness of the ferro-elastomeric gel in the presence of a magnetic field or an electric field, respectively. Therefore, the electronic controller 74 may be further configured to supply a voltage from the voltage source 86 to the ferro-elastomeric gel or, alternatively, to an electromagnetic device (not shown) adjacent the ferro-elastomeric gel to change a characteristic of the gel. It may be desirable, for example, to actively alter a spring characteristic of the elastomer 84 in response to a movement of the machine 10. This alteration, it should be appreciated, may or may not further influence an amount and/or direction of expansion or contraction of the fluid chambers 54-62.

Additional support may also be provided for the upper support member 50 with respect to the lower support member 52. For example, four flexible rods 88, 90, 92, and 94 may also be provided to interconnect the upper and lower support members 50 and 52 at corners thereof. The flexible rods 88, 90, 92, and 94 may be vertically aligned, as shown, and may be attached to the upper and lower support members 50 and 52 using any known attachment means. According to one embodiment, it may be desirable for the attachment means to include pivotable joints, such as joints including spherical rod ends, that allow horizontal movement of the upper support member 50 relative to the lower support member 52. Alternatively, however, it may also be desirable for the flexible rods 88, 90, 92, and 94 to include telescoping features to allow vertical movement of the upper support member 50 relative to the lower support member 52, and prevent relative horizontal movement. It should be appreciated that the suspension system 40 may be used with additional suspension, damping, and height adjustment devices, as are well known in the art.

Although the suspension system 40 is depicted between the upper and lower support members 50 and 52 of the seat assembly 16, it is also contemplated that the suspension system 40 may be incorporated into the seat cushion 36 of the seat assembly 16. For example, the electronic controller 74 may control a fluid amount within one or more of the fluid chambers 54-62 to actively counteract a machine movement and/or provide semi-active damping of a machine movement within the seat cushion 36. The elastomer 84 may also be provided within the seat cushion 36, and may surround at least a portion, and preferably a majority, of each of the fluid chambers 54-62. The fluid chambers 54-62 may be used in conjunction with the elastomer 84, as described herein, to provide desired control of the seat cushion 36.

### INDUSTRIAL APPLICABILITY

Referring to FIGS. 1-3, an exemplary embodiment of a machine 10 may include a wheel tractor scraper, as shown, or any other machine or vehicle, having an operator control station 12. The operator control station 12 is mounted to a body 14 of the machine 10 and may include a seat assembly 16. The operator control station 12 may include various other devices, including, but not limited to, one or more machine operation controllers. For example, machine operation controller 42 may include a directional controller, while machine operation controller 44 may be used to control movement of an implement 18 of the machine 10.

An operator of the machine 10 may have to remain seated, and typically coupled to the seat assembly 16 via a seatbelt, for extended periods of time while controlling operation of the machine 10. The seat assembly 16, therefore, should be designed to permit the operator to perform tasks from a comfortable position and isolate the operator, as much as possible, from vibrations of the machine 10. This is of particular importance for machines subject to high vibration levels. Wheel tractor scrapers, for example, often perform initial clearing and excavation and, therefore, operate over very rough terrain. These increased vibrations may interfere with operator control and may cause the operator to fatigue more quickly, and may disrupt machine operation.

During a typical machine operation, an operator may sit in the seat assembly 16 and adjust the height of the seat assembly 16, such as by actuating a height adjustment controller 46 to control a height adjustment feature of the seat assembly 16. Specifically, the height adjustment feature may be incorporated with, or separate from, the fluid chambers 54-62, to increase or decrease the volume of the fluid within chambers 54-62, thereby adjusting the seat assembly 16 to a desired height. It should be appreciated that the elastomer 84 and flexible rods 88, 90, 92, and 94, and any additional devices may also be provided for supporting the upper support member 50 a predetermined distance from the lower support member 52. Once at a desired height, the operator may actuate a machine operation controller, such as a directional controller 42, to move the machine 10 in a desired direction. As the machine 10 moves, it may encounter a rut that causes the machine 10 to drop.

The suspension system 40 may isolate the seat assembly 16 and, therefore, the operator from this movement. Specifically, the machine movement may be sensed using a motion sensing device 96, such as one or more accelerometers or other motion sensing devices, positioned at any desired position of the machine 10 or seat assembly 16. The electronic controller 74, in communication with the motion sensing device 96, instantaneously, or near instantaneously, directs a movement of the seat assembly 16 to, at least partially, counteract the machine movement and/or alter a damping characteristic of the suspension system 40. Specifically, the electronic controller 74 may actuate each of the electronically controlled valves 64-72 to increase the amount of pressurized fluid within the fluid chambers 54-62.

It should be appreciated that the resulting increase of fluid within the fluid chambers 54-62 may have varying effects, depending on the materials and configurations employed for fluid chambers 54-62. For example, the fluid chambers 54-62 may be configured to elongate when a fluid amount is increased, thereby increasing a vertical distance between the upper support member 50 and the lower support member 52. Alternatively, the fluid chambers 54-62 may comprise a material that limits deformation of the fluid chambers 54-62. According to this embodiment, therefore, an increase in the amount of fluid within the fluid chambers 54-62 may result in an increase in firmness of the fluid chambers 54-62 and, as a result, the suspension system 40. The elastomer 84 may be utilized in any of the embodiments to influence an amount and/or direction of expansion or contraction of the fluid chambers 54-62.

As the machine 10 passes out of the rut and moves upward, the electronic controller 74 may responsively actuate each of the electronically controlled valves 64-72 to decrease the amount of pressurized fluid within the fluid chambers 54-62 to isolate the seat assembly 16 and operator from movement. Fluid chambers 54-62, again, provide isolation of movement by increasing or decreasing the amount of pressurized fluid to bias the upper support member 50 of the suspension system 40 away from the lower support member 52. It should also be appreciated that an increase or decrease in the fluid amount within the fluid chambers 54-62 may cause shock absorption and/or damping characteristics of the fluid chambers 54-62 to vary. Since the fluid chambers 54-62 may be individually controlled, it should also be appreciated that a movement and/or firmness may be independently selected for respective portions of the seat assembly 16. The machine 10 then returns to an initialized position in which the fluid chambers 54-62 bias the upper support member 50 of the suspension system 40 away from the lower support member 52.

According to another typical machine operation, the machine 10 may hit a rut that causes the machine 10 to roll about a horizontal axis X in a direction indicated by the arrow (shown in FIG. 3). To counteract this movement, the electronic controller 74 may actuate electronically controlled valves 65, 69, and 70 to increase the fluid amount within fluid chambers 55, 59, and 60. Simultaneously, the electronic controller 74 may cause a decrease in the fluid amount within fluid chambers 57, 61, and 62. The fluid amount within fluid chambers 54, 56, and 58 may or may not be changed, depending on a control scheme of the electronic controller 74.

As the machine 10 passes out of the rut, and rolls in the opposite direction about the horizontal axis X, the electronic controller 74 may responsively actuate each of the electronically controlled valves 64-72 to adjust the amount of pressurized fluid within the fluid chambers 54-62 to, again, counteract the machine movement. Specifically, the electronic controller 74 may actuate electronically controlled valves 65, 69, and 70 to decrease the fluid amount within fluid chambers 55, 59, and 60. Simultaneously, the electronic controller 74 may cause an increase in the fluid amount within fluid chambers 57, 61, and 62. Again, the fluid amount within fluid chambers 54, 56, and 58 may or may not be changed. It should be appreciated that the common fluid source 78 may be positioned a predetermined distance from the fluid chambers 54-62 to reduce the response time in increasing and/or decreasing the fluid amounts within the fluid chambers 54-62. For example, it may be desirable to support the common fluid source 78 on at least one of the upper and lower support members 50 and 52.

The electronic controller 74 may utilize any desirable control scheme for adjusting the fluid amount within each of the fluid chambers 54-62 to limit movement of the seat assembly 16, as much as possible, in response to movements of the machine 10. It should be appreciated that the number of fluid chambers 54-62 in the array and the amount of fluid flow between the fluid chambers 54-62 and the common fluid source 78 may be varied to achieve different ride characteristics. It should also be appreciated that the electronic controller 74 may monitor various sensors of the fluid chambers 54-62, such as the pressure sensor 82, to determine current conditions of the fluid chambers 54-62 and update the control scheme accordingly.

The suspension system 40 of the present disclosure provides an active and/or semi-active suspension system for supporting a seat assembly 16 of a machine 10. Specifically, by utilizing an array of fluid chambers 54-62 surrounded, at least in part, by an elastomer 84, the suspension system 40 may provide both suspension and damping using relatively few components, which may lead to increased reliability of the suspension system 40. It should be appreciated that the number, sizes, and arrangement of the fluid chambers 54-62 within the array may be selected to isolate the operator from lateral and fore and aft vibrations, as much as possible.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A suspension system for a seat assembly of a machine, comprising:
an upper support member;
a lower support member;
an array of fluid chambers operatively connected to the upper and lower support members, wherein each of the fluid chambers includes an electronically controlled valve for controlling an amount of fluid within the fluid chambers;
an elastomer coupled between the upper support member and the lower support member; and
an electronic controller in communication with each of the electronically controlled valves, wherein the electronic controller is configured to actuate the electronically controlled valves in response to a movement of the machine.

2. The suspension system of claim 1, wherein the array includes four fluid chambers operatively connected to the upper and lower support members at perimeters thereof and one fluid chamber connected to the upper and lower support members at central portions thereof.

3. The suspension system of claim 2, wherein the array further includes nine fluid chambers arranged in a three by three matrix.

4. The suspension system of claim 3, wherein the elastomer includes an elastomeric gel surrounding at least a portion of each of the fluid chambers.

5. The suspension system of claim 4, wherein the elastomeric gel includes a ferro-elastomeric gel.

6. The suspension system of claim 5, further including a voltage source, wherein the electronic controller is further configured to supply a voltage from the voltage source to the ferro-elastomeric gel.

7. The suspension system of claim 4, further including a common source of pressurized fluid connected to the fluid chambers, wherein the common source of pressurized fluid is supported on at least one of the upper support member and the lower support member.

8. The suspension system of claim 7, wherein each of the fluid chambers includes a pneumatic bladder.

9. The suspension system of claim 7, wherein each of the fluid chambers includes a hydraulic cylinder.

10. The suspension system of claim 1, further including at least four flexible rods, wherein the flexible rods are vertically aligned and positioned to interconnect the upper and lower support members at corners thereof.

11. A method of supporting a seat assembly of a machine, comprising:
supporting the seat assembly of the machine using an array of fluid chambers surrounded, at least in part, by an elastomer;
sensing a movement of the machine; and
changing a fluid amount in at least one of the fluid chambers in response to the machine movement.

12. The method of claim 11, wherein the changing step includes actuating an electronically controlled valve of each of the fluid chambers.

13. The method of claim 12, wherein the changing step further includes increasing an amount of pressurized fluid within at least one of the fluid chambers to, at least partially, counteract the machine movement.

14. The method of claim 13, wherein the changing step further includes simultaneously decreasing the amount of pressurized fluid within at least one of the fluid chambers to, at least partially, counteract the machine movement.

15. The method of claim 14, further including reducing a response time of at least one of the increasing and decreasing steps by positioning a common pressurized fluid source a predetermined distance from the fluid chambers.

16. A seat cushion for a seat assembly of a machine, comprising:
an array of fluid chambers operatively disposed within the seat cushion, wherein each of the fluid chambers includes an electronically controlled valve for controlling an amount of fluid within the fluid chambers;
an elastomer surrounding at least a portion of each of the fluid chambers; and
an electronic controller in communication with each of the electronically controlled valves, wherein the electronic controller is configured to actuate the valves in response to a movement of the machine.

17. The seat cushion of claim 16, wherein the array includes four fluid chambers operatively connected to a top and a bottom of the seat cushion at perimeters thereof and one fluid chamber connected to the top and bottom at central portions thereof.

18. The seat cushion of claim 17, wherein the array further includes nine fluid chambers arranged in a three by three matrix.

19. The seat cushion of claim 18, wherein each of the fluid chambers includes at least one of a pneumatic bladder and a hydraulic bladder.

20. The seat cushion of claim 18, wherein the elastomer includes an elastomeric gel.
